(19) United States
(12) Patent Application Publication
(10) Pub. No.: US 2021/0076219 A1
(43) Pub. Date: Mar. 11, 2021

(54) SYSTEM AND METHOD FOR DETECTING REMOTE INTRUSION OF AN AUTONOMOUS VEHICLE

(71) Applicant: Walmart Apollo, LLC, Bentonville, AR (US)

(72) Inventors: John J. O'BRIEN, Farmington, AR (US); Robert CANTRELL, Herndon, VA (US); David WINKLE, Bella Vista, AR (US); Todd MATTINGLY, Bentonville, AR (US); Donald R. HIGH, Noel, MO (US)

(73) Assignee: Walmart Apollo, LLC, Bentonville, AR (US)

(21) Appl. No.: 16/219,627

(22) Filed: Dec. 13, 2018

Related U.S. Application Data
(60) Provisional application No. 62/599,457, filed on Dec. 15, 2017.

(51) Int. Cl. H04W 12/12; B64C 39/02; B64D 45/00; G05D 1/10; G05D 1/00

(52) U.S. Cl. CPC H04W 12/1204; B64C 39/024; B64D 45/0018; B64C 2201/141; G05D 1/0022; B64C 2201/027; G05D 1/106

(57) ABSTRACT

Systems, methods, and computer-readable storage media for determining that an undesired entity is attempting to gain control over an unmanned vehicle, or, in other words, how to determine that an unmanned vehicle is being attacked. In instances of a physical attack, the unmanned vehicle must recognize the physical actions taken against it as hostile. In instances of RF hacking, or attempts to take remote control, the unmanned vehicle must recognize that the signals being received are from a hostile source. With each type of attack, the unmanned vehicle must (1) identify the actions being taken against it, whether physical or electromagnetic; (2) compare the identified actions to previous actions to determine if the actions fit a hostile profile; and (3) upon identifying the actions as hostile, enact counter-measures to prevent the hostile actions.

### PRIORITY

This application claims priority to U.S. Provisional Patent Application No. 62/599,457, filed Dec. 15, 2017, the contents of which are incorporated herein in their entirety.

### BACKGROUND

### 1. Technical Field

The present disclosure relates to detecting hacking of autonomous vehicles, and more specifically to detecting remote intrusion of an autonomous vehicle based on signal patterns.

### 2. Introduction

Autonomous vehicles, such as drones (aerial and/or ground), robots, self-driving cars, or UAVs (Unmanned Aerial Vehicles) are quickly becoming more prevalent in society. Traditional remote-controlled vehicles or drones have required human pilots, or drivers, to guide the vehicles via RF (Radio Frequency) transmissions. By contrast, autonomous vehicles have sufficient programming to make many navigation decisions without human input.

Despite having sufficient programming to autonomously navigate and travel, autonomous vehicles do require inputs which direct them on where and when to travel, what items to transport or retrieve, identify obstacles or precautions for the planned route, etc. Generally, these inputs are transmitted by a known, “friendly” source. However, in some cases non-friendly parties may attempt to hack, or otherwise perform a remote intrusion, on the autonomous vehicle.

### TECHNICAL PROBLEM

How to identify, on an autonomous vehicle, if control signals being received are from a friendly source or represent a takeover attempt.

### SUMMARY

An exemplary method for performing the concepts disclosed herein can include: receiving, on an autonomous vehicle, a first communication on a first channel, the first communication being a friendly communication of known origin; receiving, on the autonomous vehicle, a second communication on the first channel, the second communication being of unknown origin and unknown intention; determining, on a processor located on the autonomous vehicle, that the second communication is of harmful intent by: comparing a first geographic location from which the first communication was received to a second geographic location from which the second communication was received, to yield a first comparison; comparing first instructions received in the first communication to second instructions received in the second communication, to yield a second comparison; comparing at least one of encryption and modulation of the first communication to that of the second communication, to yield a third comparison; comparing a first radio frequency power level of the first communication to a second radio frequency power level of the second communication, to yield a fourth comparison; comparing the second communication to historical communications stored in a historical communication database, to yield a fifth comparison; calculating a risk factor of the second communication based on the first comparison, the second comparison, the third comparison, the fourth comparison, and the fifth comparison; and identifying the risk factor as above a threshold, such that the second communication is determined to be of harmful intent; changing communication channels for the autonomous vehicle from the first channel to a second channel based on the second communication having harmful intent.

An exemplary unmanned aerial drone configured according to this disclosure can include: a processor; a communications system configured to transmit and receive data; and a computer-readable storage medium having instructions stored which, when executed by the processor, cause the processor to perform operations comprising: receiving, on an autonomous vehicle, a first communication on a first channel, the first communication being a friendly communication of known origin; receiving, on the autonomous vehicle, a second communication on the first channel, the second communication being of unknown origin and unknown intention; determining, on a processor located on the autonomous vehicle, that the second communication is of harmful intent by: comparing first instructions received in the first communication to second instructions received in the second communication, to yield a first comparison; comparing a first radio frequency power level of the first communication to a second radio frequency power level of the second communication, to yield a second comparison; comparing the second communication to historical communications stored in a historical communication database, to yield a third comparison; calculating a risk factor of the second communication based on the first comparison, the second comparison, and the third comparison; and identifying the risk factor as above a threshold, such that the second communication is determined to be of harmful intent; causing the communications system to change communication channels for the autonomous vehicle from the first channel to a second channel based on the second communication having harmful intent.

An exemplary non-transitory computer-readable storage medium configured according to this disclosure can have instructions stored which, when executed by a computing device, cause the computing device to perform operations including: receiving a first communication on a first channel, the first communication being a friendly communication of known origin, and the first communication being directed to an autonomous vehicle; receiving a second communication on the first channel, the second communication being of unknown origin and unknown intention, and the second communication being directed to the autonomous vehicle; determining that the second communication is of harmful intent by: comparing first instructions received in the first communication to second instructions received in the second communication, to yield a first comparison; comparing at least one of encryption and modulation of the first communication to that of the second communication, to yield a second comparison; comparing a first radio frequency power level of the first communication to a second radio frequency power level of the second communication, to yield a third comparison; calculating a risk factor of the second communication based on the first comparison, the second comparison, and the third comparison; and identifying the risk factor as above a threshold, such that the second communication is determined to be of harmful intent; changing communication channels for the autonomous vehicle from the first channel to a second channel based on the second communication having harmful intent.

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

### BRIEF DESCRIPTION OF THE DRAWINGS

FIG. 1 illustrates an example of ground stations communicating with an aerial drone;

FIG. 2 illustrates exemplary power levels of signals being received by an unmanned vehicle;

FIG. 3 illustrates an onboard navigation system for an unmanned vehicle being exposed to friendly and harmful signals;

FIG. 4 illustrates an example method embodiment; and

FIG. 5 illustrates an exemplary computer.

### DETAILED DESCRIPTION

Various embodiments of the disclosure are described in detail below. While specific implementations are described, it should be understood that this is done for illustration purposes only. Other components and configurations may be used without parting from the spirit and scope of the disclosure.

The present disclosure addresses how to determine that an undesired entity is attempting to gain control over an unmanned vehicle, or, in other words, how to determine that an unmanned vehicle is being attacked. In instances of a physical attack, the unmanned vehicle must recognize the physical actions taken against it as hostile. In instances of RF (Radio Frequency) hacking, or attempts to take control of the vehicle, the unmanned vehicle must recognize that the signals being received are from a hostile source. With each type of attack, the unmanned vehicle should (1) identify the actions being taken against it, whether physical or electromagnetic; (2) compare the identified actions to previous actions to determine if the actions fit a hostile profile; and (3) upon identifying the actions as hostile, enact counter-measures to prevent the hostile actions.

To identify physical attacks and successfully counter those physical attacks, the unmanned vehicle must have sensors capable of detecting the type of attack. In the case of a projectile, net, trap, etc., the unmanned vehicle can be equipped with image sensors which can take photographs on a periodic basis, compare images from those photographs to a database of images to determine what is physically occurring around the unmanned vehicle, and thereby identify when a threat is present. For example, an aerial drone may take photographs on a periodic basis (i.e., every second, every 0.3 seconds, etc.) while flying. These photographs may be taken in 360° around the drone, and may further include photographs above and/or below the drone. These photographs can, for the purpose of the photographic analysis, be combined together to form a contiguous photograph.

The photographic analysis can identify objects within the photograph(s). For example, a driverless car may perform an image analysis on the photograph and identify a net in the direction of travel of the car, then take appropriate countermeasures. The photographic analysis can also identify if the sensors are being impeded, blocked, or otherwise interfered with. For example, if the images captured are progressively getting darker, and the route of the unmanned vehicle does not indicate tunnels or other light impediments, the system can determine that the drone is either off-course or being interfered with, and take corresponding action. Performance of the photographic analysis can be performed by a specialized image analysis processor, where the image analysis processor is configured to (1) retrieve images from a database of comparison images at a faster rate than a generic processor, (2) compare stored images to the current images from around the unmanned vehicle faster or more thoroughly than a generic processor, and/or (3) store the current images in a more efficient manner (in terms of time to store the image and/or in terms of how fast the image can be retrieved in the future) in the database.

Other types of sensors, beyond imaging/photographic sensors, which can be used by the unmanned vehicle to identify physical threats can include infrared scanners, accelerometers, temperature sensors, or any other type of sensor. When these sensors are deployed, the analysis of the data from the sensors can be performed in parallel with the data from other sensors, then combined together to form a final analysis. For example, data from a thermal sensor analysis can be combined with data from a photograph analysis to determine that a picture of a bird near the unmanned vehicle is not a living bird. In other configurations, the analyses can be performed serially based on the type of object identified in a first analysis. For example, if the photograph analysis detects an image of a bird, the system could engage the thermal sensors to detect if there is more heat coming from the bird than from surrounding objects, and thereby determine if the bird is a living bird or a photograph.

When identifying RF, electromagnetic, or other non-physical attacks, the unmanned vehicle can capture the signals being received from friendly and unfriendly sources, then compare the respective signals to determine that there is more than one source for the signals. Because there may be instances where friendly signals are being received from more than one source, the system can then evaluate if all of the respective signals are friendly. To do so, the system can compare the respective power levels being received to past, concurrently received, or expected, signal power levels.

For example, when multiple signals are detected, one way in which the system can determine that an intrusion attempt is being made is by comparing the RF power levels of the signals being received from a known source and the new signal being received from the unknown source. If the new signal is above a threshold value (i.e., a percentage above the known signals power level), the new signal may be determined to be of an unfriendly nature. Likewise, if the new signal is interfering with the known signal, the new signal may likewise be determined to be unfriendly.

Similar analysis can be performed with respect to the frequencies, bandwidths, modulation format, encryption, etc., of the respective signals being detected, that is, determination that an intrusion attempt is occurring can be based on a new signal exceeding, or being below, the previous or expected signal by a threshold amount. For example, if the unmanned vehicle had been receiving signals on a central frequency of “X”, and the newly detected signal has a central frequency of “X+50 MHz”, the system may determine that such differentiation is indicative of an intrusion attempt. However, the system may determine that a signal only 5 MHz off of the expected signal does not exceed the threshold. Likewise, if normal “safe” signals are received in a first modulation format (such as 8PSK (Eight Phase Shift Keying)), and a new signal is unexpectedly received in a second modulation format (such as QPSK (Quadrature Phase Shift Keying)), the system can flag the second signal as being from a questionable source.

Such thresholds can be based on historical data across multiple unmanned vehicles. As an individual unmanned vehicle receives and records signal data, the data can be transmitted back to a central location for compilation and analysis with that of other unmanned vehicles. This compiled data can be analyzed (based on the outcomes of specific circumstances), and used to produce updated detection algorithms which are then transmitted to the unmanned vehicles. In some configurations, such updates can be identified and generated by a single unmanned vehicle (i.e., without needing to transmit the data to another location). Regardless of whether the updates are generated based on a single unmanned vehicle or multiple unmanned vehicles, the updates provide continual improvements to the navigation system based on activity detected by sensors.

When certain types of unfriendly RF are identified, the system may need to determine if the signal is intended to hack, or take control of the autonomous vehicle, or if the unfriendly RF is designed to harm the electronics of the unmanned vehicle. This aggressive RF attack could, for example, be used to disable the unmanned vehicle, allowing saboteurs to recover the unmanned vehicle and any cargo the vehicle may be carrying. After making the determination, the unmanned vehicle may take distinct countermeasures based on the intention identified.

RF detection can also be used to identify the source of various signals being received by the unmanned vehicle, such that the relative identities of the transmitting bodies can be compared to known sources. For example, if an aerial drone regularly receives RF signals from a particular ground station, then begins receiving new RF signals from a new, distinct ground station, the aerial drone can identify the new ground station as a questionable, or unfriendly signal source.

In some cases, the unmanned vehicle may be configured to combine both RF analysis and image analysis. For example, the image analysis performed by an unmanned vehicle may identify that there is a second, unknown unmanned vehicle operating nearby. The RF analysis of the unmanned vehicle may identify the source of an RF signal as coming from a mobile location, and upon combining the RF analysis and the image analysis, the unmanned drone can determine that the second drone is the source of the unfriendly signal. Such determinations can further made by comparing the second unmanned vehicle to a list of known unmanned vehicles (a “friends” directory).

In some configurations, determinations of “friendly” or “unfriendly” can be made using a decision tree, whereas in other configurations the decision can be based on a weighted equation, where each factor (i.e., time of day, location, signal strength, data contained in the unknown signal, etc.) can be weighed. Yet other configurations can rely on a decision tree where individual decisions within the tree are made with weighted equations. Overtime, the system can modify the weights used in the weighted calculations based on RF patterns, patterns in physical surroundings, success at predicting unfriendly signals/friendly signals, or other factors. This iterative, machine learning, can modify the code used to determine if an intrusion is taking place. The modifications to the memory storing the automated vehicle decision tree code can be made as the questionable signals are being received, such that the automated vehicle can react to possible intrusions by changing its code while an intrusion attempt is taking place.

With that basis, the disclosure turns to the figures for particular examples.

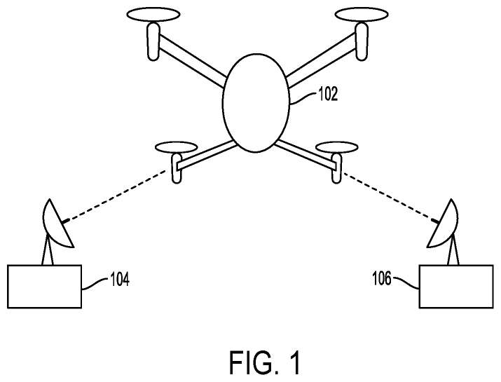

FIG. 1 illustrates an example of ground stations communicating with an unmanned vehicle which is an aerial drone 102. In other configurations, the unmanned vehicle can be a driverless car, a delivery robot, a warehouse robot, or any other type of vehicle configured to move autonomously. In this example, the aerial drone 102 is receiving signals from two distinct ground stations 104, 106. However, it may be that one of the ground stations 104, 106 is not operating with friendly intentions, and may be attempting to take control of (or otherwise harm) the aerial drone 102.

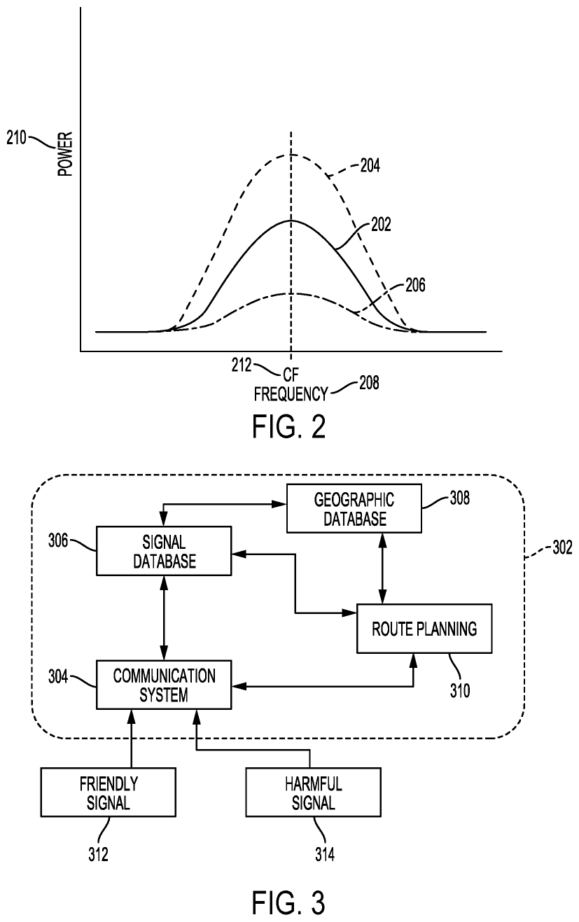

FIG. 2 illustrates exemplary power levels of signals 202, 204, 206 being received by an unmanned vehicle. As illustrated, signal strength, or power 210, is graphed against frequency 208. In this example, each of the signals 202, 204, 206 has a common Center Frequency (CF) 212. In some cases, a known signal 202 can be received for a given amount of time before a new signal 204 having a higher relative power compared to the known signal 202. Likewise, a new signal 206 may have a lower relative power compared to the known signal 202. In some instances, the known signal 202 can be reduced in power due to an interfering signal. Based on these power level comparisons, the unmanned vehicle can determine that a received signal is unfriendly, or can use the power level comparison in making such determination.

FIG. 3 illustrates an onboard navigation system 302 for an unmanned vehicle being exposed to friendly 312 and harmful signals 314. As illustrated, the navigation system 302 contains various subsystems—a communications subsystem 304, a signal database 306, a geographic database 308, and a route planning subsystem 310. The friendly 312 and harmful signals 314 are both received by the communication system 304. The signals 312, 314 are received into the communication system 304 via antennas (monopole, dipole, parabolic, or any other type of antenna), optical receptors, or any other device capable of receiving signals. The communication system 304 can be, as illustrated, in communication with a signal database 306, which can compare the received signals 312, 314 to stored signals. The stored signals can be stored in a signal database 306, which is non-transitory memory having signals stored and organized for the purpose of comparison. In some configurations, the stored signals are correlated to a geographic database 308 identifying the location where the signals stored in the signal database 306 originated. This comparison can be a comparison of power level, bandwidth, frequency, modulation, or other signal qualities. The comparison can also be a comparison of signal content, such as authentications provided by the signal to those previously provided, metadata identifying the source of the signal compared to previous metadata, instructions provided by the signal compared to previous instructions, etc. Hacking attempts may have certain characteristics, such as a particular error rate, signal strength, or type of packet. And within these types there may be changes in the signal qualities, such as data rate, frequency, channel, etc. These qualities can be evaluated to detect hacking attempts. For example, to determine if hacking may be being attempted, the system can look at the following measured in communications to and from the drone including: packet loss changes above a tolerance; bit error rate increases; signal strength increases; signal quality changes above tolerance.

The communication system 304 can communicate the instructions received in a friendly signal 312 to the route planning system 310, and can seek to inhibit or delay similar communication of the harmful signal 314. The communication system 304 can also inform the route planning system 310 of the presence of the harmful signal 314, such that the route planning system 310 can divert the unmanned vehicle away from the source of potential harm.

The route planning system 310 can be part of the autonomous vehicle which is modified due to an intrusion attempt. Continuing with the example provided above, as the unmanned vehicle is diverted away from the source of potential harm, the route planning system 310 can flag or otherwise designate geographic areas in its maps as having harmful or questionable actors. This information can be communicated back to a ground-station for further dissemination to other autonomous vehicles, or communicated directly to the other autonomous vehicles nearby. As the autonomous vehicle revisits that geographic area, it will divert itself around the geographic area based on the previous experience noted within the route planning system 310. The information recorded can also note the type of attack experienced, such that if the autonomous vehicle does need to traverse the geographic area, despite the known possibility of an attack, the autonomous vehicle can prepare ahead of time for the type of attack previously received.

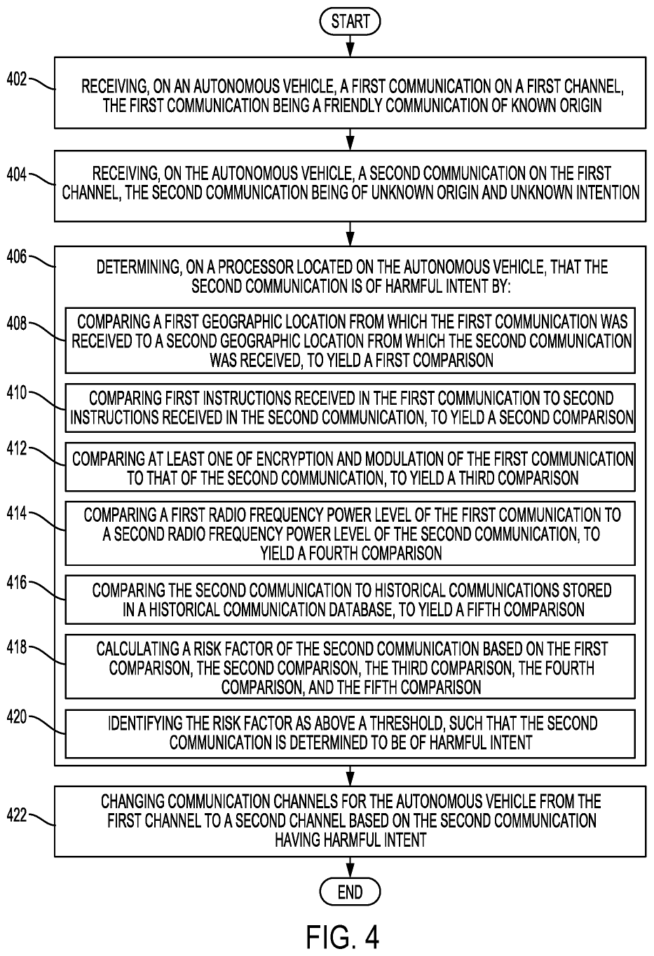

FIG. 4 illustrates an example method embodiment which can be exercised by an autonomous vehicle per the concepts disclosed herein. The steps described are exemplary only, and specific configurations may add or remove steps described, based on particular needs or configurations. The method begins by receiving, on an autonomous vehicle, a first communication on a first channel, the first communication being a friendly communication of known origin (402). The autonomous vehicle then receives a second communication on the first channel, the second communication being of unknown origin and unknown intention (404).

Having received the first and second communications, a processor located on the autonomous vehicle determines that the second communication is of harmful intent (406) by: comparing a first geographic location from which the first communication was received to a second geographic location from which the second communication was received, to yield a first comparison (408); comparing first instructions received in the first communication to second instructions received in the second communication, to yield a second comparison (410); comparing at least one of encryption and modulation of the first communication to that of the second communication, to yield a third comparison (412); comparing a first radio frequency power level of the first communication to a second radio frequency power level of the second communication, to yield a fourth comparison (414); comparing the second communication to historical communications stored in a historical communication database, to yield a fifth comparison (416); calculating a risk factor of the second communication based on the first comparison, the second comparison, the third comparison, the fourth comparison, and the fifth comparison (418); and identifying the risk factor as above a threshold, such that the second communication is determined to be of harmful intent (420). Based on that determination, the autonomous vehicle changes communication channels for the autonomous vehicle from the first channel to a second channel (422). In other configurations, the autonomous vehicle can also change navigation path, interrupt the harmful signal, or otherwise prevent the harmful signal from impacting the mission of the autonomous vehicle. Embodiments of the invention may make one or more of the comparisons, in different combinations.

In some configurations, the first instructions received in the first communication instruct the autonomous vehicle to follow a first navigational path, and the second instructions received in the second communication attempt to instruct the autonomous vehicle to follow a distinct navigational path. Based on the distinction between the first navigational path and the distinct navigational path (i.e., the differences exceed a threshold), the system can determine that the second signal is of harmful intent.

In some configurations, determining that the second communication is of harmful intent can further include: identifying an additional drone operating within a threshold distance of the autonomous vehicle; and identifying the second communication as originating at the additional vehicle. For example, if the additional vehicle is a nearby drone attempting to hack or harm the autonomous vehicle, the countermeasures of the autonomous vehicle may include evasive maneuvers away from the harmful drone.

In some configurations, the frequencies of the first channel and the second channel are very close, whereas in other configurations the first channel and the second channel are from of distinct portions of the electromagnetic spectrum. For example, the distinct portions of the electromagnetic spectrum can include two of: L-band, C-band, Ku-band, Ka-band, Wi-Fi channels, LTE bands, Bluetooth bands, Cellular bands, and Ulta-Wide Bands.

In some configurations, the first communication and the second communication can have different modulations, encryption mechanisms, or other encoding, which can provide rationale that the second communication contains harmful content. For example, in some instances the second communication may have a higher encryption (meaning the signal is harder to process) than the first channel.

In some configurations, the second communication can interfere with continued reception of the first communication. This interference can be identified by a reduction in the power level of the first communication compared to historical data for the first communication. The interference may likewise be identified by a reduction in the amount of recoverable data from the first communication compared to historical data.

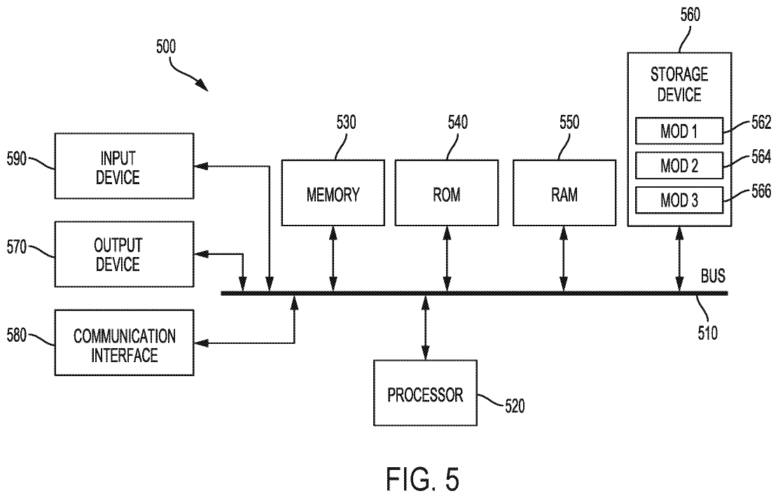

With reference to FIG. 5, an exemplary system includes a general-purpose computing device 500, including a processing unit (CPU or processor) 520 and a system bus 510 that couples various system components including the system memory 530 such as read-only memory (ROM) 540 and random access memory (RAM) 550 to the processor 520. The system 500 can include a cache of high-speed memory connected directly with, in close proximity to, or integrated as part of the processor 520. The system 500 copies data from the memory 530 and/or the storage device 560 to the cache for quick access by the processor 520. In this way, the cache provides a performance boost that avoids processor 520 delays while waiting for data. These and other modules can control or be configured to control the processor 520 to perform various actions. Other system memory 530 may be available for use as well. The memory 530 can include multiple different types of memory with different performance characteristics. It can be appreciated that the disclosure may operate on a computing device 500 with more than one processor 520 or on a group or cluster of computing devices networked together to provide greater processing capability. The processor 520 can include any general purpose processor and a hardware module or software module, such as module 1 562, module 2 564, and module 3 566 stored in storage device 560, configured to control the processor 520 as well as a special-purpose processor where software instructions are incorporated into the actual processor design. The processor 520 may essentially be a completely self-contained computing system, containing multiple cores or processors, a bus, memory controller, cache, etc. A multi-core processor may be symmetric or asymmetric.

The system bus 510 may be any of several types of bus structures including a memory bus or memory controller, a peripheral bus, and a local bus using any of a variety of bus architectures. A basic input/output (BIOS) stored in ROM 540 or the like, may provide the basic routine that helps to transfer information between elements within the computing device 500, such as during start-up. The computing device 500 further includes storage devices 560 such as a hard disk drive, a magnetic disk drive, an optical disk drive, tape drive or the like. The storage device 560 can include software modules 562, 564, 566 for controlling the processor 520. Other hardware or software modules are contemplated. The storage device 560 is connected to the system bus 510 by a drive interface. The drives and the associated computer-readable storage media provide nonvolatile storage of computer-readable instructions, data structures, program modules and other data for the computing device 500. In one aspect, a hardware module that performs a particular function includes the software component stored in a tangible computer-readable storage medium in connection with the necessary hardware components, such as the processor 520, bus 510, display 570, and so forth, to carry out the function. In another aspect, the system can use a processor and computer-readable storage medium to store instructions which, when executed by the processor, cause the processor to perform a method or other specific actions. The basic components and appropriate variations are contemplated depending on the type of device, such as whether the device 500 is a small, handheld computing device, a desktop computer, or a computer server.

Although the exemplary embodiment described herein employs the hard disk 560, other types of computer-readable media which can store data that are accessible by a computer, such as magnetic cassettes, flash memory cards, digital versatile disks, cartridges, random access memories (RAMs) 550, and read-only memory (ROM) 540, may also be used in the exemplary operating environment. Tangible computer-readable storage media, computer-readable storage devices, or computer-readable memory devices, expressly exclude media such as transitory waves, energy, carrier signals, electromagnetic waves, and signals per se.

To enable user interaction with the computing device 500, an input device 590 represents any number of input mechanisms, such as a microphone for speech, a touch-sensitive screen for gesture or graphical input, keyboard, mouse, motion input, speech and so forth. An output device 570 can also be one or more of a number of output mechanisms known to those of skill in the art. In some instances, multimodal systems enable a user to provide multiple types of input to communicate with the computing device 500. The communications interface 580 generally governs and manages the user input and system output. There is no restriction on operating on any particular hardware arrangement and therefore the basic features here may easily be substituted for improved hardware or firmware arrangements as they are developed.

Use of language such as “at least one of X, Y, and Z” or “at least one or more of X, Y, or Z” are intended to convey a single item (just X, or just Y, or just Z) or multiple items (i.e., {X and Y}, {Y and Z}, or {X, Y, and Z}). “At least one of” is not intended to convey a requirement that each possible item must be present.

The various embodiments described above are provided by way of illustration only and should not be construed to limit the scope of the disclosure. Various modifications and changes may be made to the principles described herein without following the example embodiments and applications illustrated and described herein, and without departing from the spirit and scope of the disclosure.

We claim:

1. A method comprising:
receiving, on an autonomous vehicle, a first communication on a first channel, the first communication being a friendly communication of known origin;
receiving, on the autonomous vehicle, a second communication on the first channel, the second communication being of unknown origin and unknown intention;
determining, on a processor located on the autonomous vehicle, that the second communication is of harmful intent by:
comparing a first geographic location from which the first communication was received to a second geographic location from which the second communication was received, to yield a first comparison;
comparing first instructions received in the first communication to second instructions received in the second communication, to yield a second comparison;
comparing at least one of encryption and modulation of the first communication to that of the second communication, to yield a third comparison;
comparing a first radio frequency power level of the first communication to a second radio frequency power level of the second communication, to yield a fourth comparison;
comparing the second communication to historical communications stored in a historical communication database, to yield a fifth comparison;
calculating a risk factor of the second communication based on the first comparison, the second comparison, the third comparison, the fourth comparison, and the fifth comparison; and
identifying the risk factor as above a threshold, such that the second communication is determined to be of harmful intent;
changing communication channels for the autonomous vehicle from the first channel to a second channel based on the second communication having harmful intent.

2. The method of claim 1, wherein the first instructions received in the first communication instruct the autonomous vehicle to follow a first navigational path, and the second instructions received in the second communication attempt to instruct the autonomous vehicle to follow a distinct navigational path.

3. The method of claim 1, wherein the determining that the second communication is of harmful intent further comprises:
identifying an additional drone operating within a threshold distance of the autonomous vehicle; and
identifying the second communication as originating at the additional vehicle.

4. The method of claim 1, wherein the first channel and the second channel comprise distinct portions of the electromagnetic spectrum.

5. The method of claim 4, wherein the distinct portions are two of: L-band, C-band, Ku-band, Ka-band, Wi-Fi channels, LTE bands, Bluetooth bands, Cellular bands, and Ulta-Wide Bands.

6. The method of claim 1, wherein communications via the second channel have a higher encryption than the first channel.

7. The method of claim 1, wherein the second communication interferes with continued reception of the first communication.

8. An unmanned aerial drone, comprising:
a processor;
a communications system configured to transmit and receive data; and
a computer-readable storage medium having instructions stored which, when executed by the processor, cause the processor to perform operations comprising:
receiving, on an autonomous vehicle, a first communication on a first channel, the first communication being a friendly communication of known origin;
receiving, on the autonomous vehicle, a second communication on the first channel, the second communication being of unknown origin and unknown intention;
determining, on a processor located on the autonomous vehicle, that the second communication is of harmful intent by:
comparing first instructions received in the first communication to second instructions received in the second communication, to yield a first comparison;
comparing a first radio frequency power level of the first communication to a second radio frequency power level of the second communication, to yield a second comparison;
comparing the second communication to historical communications stored in a historical communication database, to yield a third comparison;
calculating a risk factor of the second communication based on the first comparison, the second comparison, and the third comparison; and
identifying the risk factor as above a threshold, such that the second communication is determined to be of harmful intent;
causing the communications system to change communication channels for the autonomous vehicle from the first channel to a second channel based on the second communication having harmful intent.

9. The unmanned aerial drone of claim 8, wherein the first instructions received in the first communication instruct the autonomous vehicle to follow a first navigational path, and the second instructions received in the second communication attempt to instruct the autonomous vehicle to follow a distinct navigational path.

10. The unmanned aerial drone of claim 8, wherein the determining that the second communication is of harmful intent further comprises:
identifying an additional drone operating within a threshold distance of the autonomous vehicle; and
identifying the second communication as originating at the additional vehicle.

11. The unmanned aerial drone of claim 8, wherein the first channel and the second channel comprise distinct portions of the electromagnetic spectrum.

12. The unmanned aerial drone of claim 11, wherein the distinct portions are two of: L-band, C-band, Ku-band, Ka-band, Wi-Fi channels, LTE bands, Bluetooth bands, Cellular bands, and Ulta-Wide Bands.

13. The unmanned aerial drone of claim 8, wherein communications via the second channel have a higher encryption than the first channel.

14. The unmanned aerial drone of claim 8, wherein the second communication interferes with continued reception of the first communication.

15. A non-transitory computer-readable storage medium having instructions stored which, when executed by a computing device, cause the computing device to perform operations comprising:
receiving a first communication on a first channel, the first communication being a friendly communication of known origin, and the first communication being directed to an autonomous vehicle;
receiving a second communication on the first channel, the second communication being of unknown origin and unknown intention, and the second communication being directed to the autonomous vehicle;
determining that the second communication is of harmful intent by:
comparing first instructions received in the first communication to second instructions received in the second communication, to yield a first comparison;
comparing at least one of encryption and modulation of the first communication to that of the second communication, to yield a second comparison;
comparing a first radio frequency power level of the first communication to a second radio frequency power level of the second communication, to yield a third comparison;
calculating a risk factor of the second communication based on the first comparison, the second comparison, and the third comparison; and
identifying the risk factor as above a threshold, such that the second communication is determined to be of harmful intent;
changing communication channels for the autonomous vehicle from the first channel to a second channel based on the second communication having harmful intent.

16. The non-transitory computer-readable storage medium of claim 15, wherein the first instructions received in the first communication instruct the autonomous vehicle to follow a first flight path, and the second instructions received in the second communication attempt to instruct the autonomous vehicle to follow a distinct flight path.

17. The non-transitory computer-readable storage medium of claim 15, wherein the determining that the second communication is of harmful intent further comprises:
identifying an additional drone operating within a threshold distance of the autonomous vehicle; and
identifying the second communication as originating at the additional drone.

18. The non-transitory computer-readable storage medium of claim 15, wherein the first channel and the second channel comprise distinct portions of the electromagnetic spectrum.

19. The non-transitory computer-readable storage medium of claim 18, wherein the distinct portions are two of: L-band, C-band, Ku-band, Ka-band, Wi-Fi channels, LTE bands, Bluetooth bands, Cellular bands, and Ulta-Wide Bands.

20. The non-transitory computer-readable storage medium of claim 15, wherein communications via the second channel have a higher encryption than the first channel.
